(19) United States
(12) Patent Application Publication
(10) Pub. No.: US 2005/0142922 A1
(43) Pub. Date: Jun. 30, 2005

(54) Electrical connector assembly

(76) Inventors: Junya Akasaka, Kanagawa (JP); Izumi Hasegawa, Kanagawa (JP)

Correspondence Address: BARLEY SNYDER, LLC, 1000 WESTLAKES DRIVE, SUITE 275, BERWYN, PA, 19312, US

(21) Appl. No.: 11/014,010

(22) Filed: Dec. 16, 2004

(30) Foreign Application Priority Data
Dec. 25, 2003 (JP) 2003-430593

(51) Int. Cl. H01R 13/625

(52) U.S. Cl. 439/346

(57) ABSTRACT

An electrical connector assembly comprises a first connector and a second connector. The first connector and the second connector each have a housing with a contact receiving wall. Contacts are disposed in the housings of the first and second connectors. Each of the contacts has a contact portion, a terminal, a convex projection, and a press-fit portion. The convex projection is arranged between the contact portion and the press-fit portion. The convex projection abuts the contact receiving wall in the housing in which the contact is disposed to space the contact from the contact receiving wall when the first and second connectors are mated. A protective lip is formed on the contact receiving walls of the first and second connectors. The protective lip is formed adjacent to the contact portions of the contacts.

### FIELD OF THE INVENTION

The invention relates to an electrical connector assembly and, more particularly, to an electrical connector assembly having a first connector and a second connector that each have contacts with convex projecting portions and housings with protective lips for preventing damage to contact portions of the contacts.

### BACKGROUND OF THE INVENTION

Electrical connector assemblies are commonly made with mating contacts having contact portions with the same shape in order to reduce manufacturing costs, ease control of contact force, lower mating force, etc. One example of such an electrical connector assembly is shown in FIGS. 8-9 and disclosed in Japanese Patent Laid-Open No. 2-49373.

As shown in FIG. 8, the electrical connector assembly includes a first connector 80 and a second connector 90. As shown in Part (A) of FIG. 8, the first connector 80 includes a housing 82 having a contact 81. The contact 81 has a contact portion 81, a press-fit portion 812, and a terminal (not shown). The press-fit portion 812 is press-fit into the housing 82. Between the contact portion 811 and the press-fit portion 812, the contact 81 has a fixed section 813. The fixed section 813 is fixed along an inner wall of the housing 82.

The contact portion 811 and the fixed section 813 of the contact 81 are disposed in an interior of an opening 821 formed in the housing 82. The contact portion 811 is positioned between the opening 821 and a cavity 822. The contact portion 811 is fixed in a position adjacent to the cavity 822 such that the contact portion 811 enters the cavity 822 upon engagement with the second connector 90. The terminal (not shown) is connected to a substrate (not shown). The housing 82 of the first connector 80 may be fabricated by use of a split mold capable of being divided in a vertical direction of Part (A) of FIG. 8.

As shown in Part (B) of FIG. 8, the second connector 90 includes a housing 92 having a contact 91. The contact 91 has a contact portion 911, a press-fit portion 912, and a terminal (not shown). The press-fit portion 912 is press-fit into the housing 92. Between the contact portion 911 and the press-fit portion 912, the contact 91 has a fixed section 913. The fixed section 913 is fixed along an inner wall of the housing 92. The contact portion 911 of the contact 91 has the same shape as the contact portion 811 of the contact 81 shown in Part (A) of FIG. 8.

The contact portion 911 and the fixed section 913 are arranged in an interior of an opening 921 formed in the housing 92. The contact portion 911 is positioned between the opening 921 and a cavity 922. The cavity 922 is formed adjacent to the contact portion 911 such that the cavity 922 receives the contact portion 911 upon engagement with the first connector 80. The terminal (not shown) is connected to a substrate (not shown). The housing 92 is fabricated by use of a split mold capable of being divided in a vertical direction of Part (B) of FIG. 8.

As shown in FIG. 9, when the first connector 80 and the second connector 90 are mated, the contact portion 811 of the contact 81 of the first connector 80 comes into contact with the fixed section 913 of the contact 91 of the second connector 90 and the contact portion 911 of the contact 91 of the second connector 90 comes into contact with the fixed section 813 of the contact 81 of the first connector 80. The fixed sections 813, 913 of the contacts 81, 91 are disposed along the inner walls of the respective housings 82, 92 such that the positions of the fixed sections 813, 913 are fixed. As a result, the contact portions 911, 811 and not the fixed sections 813, deform when the contact portions 911, 811 come into contact with the fixed sections 813, 913. Because contact occurs between an elastic part and an inelastic part, the electrical contact between the two contacts 81, 91 is stable.

Because the contact portions 811, 911 of the contacts 81, 91 in the first connector 80 and the second connector 90 are unprotected in an unmated state, there is a possibility that something might come into contact with leading ends of the contact portions 811, 911, which may cause deformation of the contact portions 811, 911. Additionally, when the first connector 80 and the second connector 90 are mated, there is a possibility that either the first connector 80 or the second connector 90 might come into contact with the leading ends of the contact portions 811, 911, which may also cause deformation of the contact portions 811, 911.

To prevent the leading ends of the contact portions 811, 911 from being damaged, protective lips (not shown) may be formed of the housings 82, 92 near the leading ends of the contact portions 811, 911 of the contacts 81, 91. Forming the protective lips (not shown) on the housings 82, 92 of the first connector 80 and the second connector 90, however, will make it impossible to fabricate the housings 82, 92 with a simple split mold, which will increase manufacturing costs.

### SUMMARY OF THE INVENTION

It is therefore an object of the invention to provide an inexpensive electrical connector assembly that includes a first connector and a second connector that each have similarly formed contacts and housings with protective lips for preventing damage to contact portions of the contacts.

This and other objects are achieved by an electrical connector assembly comprising a first connector and a second connector. The first connector and the second connector each have a housing with a contact receiving wall. Contacts are disposed in the housings of the first and second connectors. Each of the contacts has a contact portion, a terminal, a convex projection, and a press-fit portion. The convex projection is arranged between the contact portion and the press-fit portion. The convex projection abuts the contact receiving wall in the housing in which the contact is disposed to space the contact from the contact receiving wall when the first and second connectors are mated. A protective lip is formed on the contact receiving walls of the first and second connectors. The protective lip is formed adjacent to the contact portions of the contacts.

This and other objects are further achieved by a connector comprising a housing having a contact receiving wall. Contacts are disposed in the housing. Each of the contacts has a contact portion, a terminal, a convex projection, and a press-fit portion. The convex projection is arranged between the contact portion and the press-fit portion. The convex projection abuts the contact receiving wall to space the contact from the contact receiving wall. A protective lip is formed on the contact receiving wall adjacent to the contact portions of the contacts.

### BRIEF DESCRIPTION OF THE DRAWINGS

FIG. 1 is a perspective view of a first connector of an electrical connector assembly according to an embodiment of the invention;

FIG. 2 is a perspective view of a second connector of the electrical connector assembly according to an embodiment of the invention;

FIG. 3 is a schematic sectional view of a connecting plate of a grounding member soldered to a substrate;

FIG. 4 is a sectional view of the first connector of FIG. 1 mated with the second connector of FIG. 2;

FIG. 5 is another sectional view of the first connector of FIG. 1 mated with the second connector of FIG. 2;

FIG. 6 is a perspective view of a contact of the first connector of FIG. 1 and a contact of the second connector of FIG. 2;

FIG. 7 is an explanatory drawing of a method of forming convex projections on the contacts;

FIG. 8 is a sectional view of a conventional electrical connector assembly disclosed in Japanese Patent Laid-Open No. 2-49373; and

FIG. 9 is another sectional view of the conventional electrical connector assembly disclosed in Japanese Patent Laid-Open No. 2-49373.

### DETAILED DESCRIPTION OF THE INVENTION

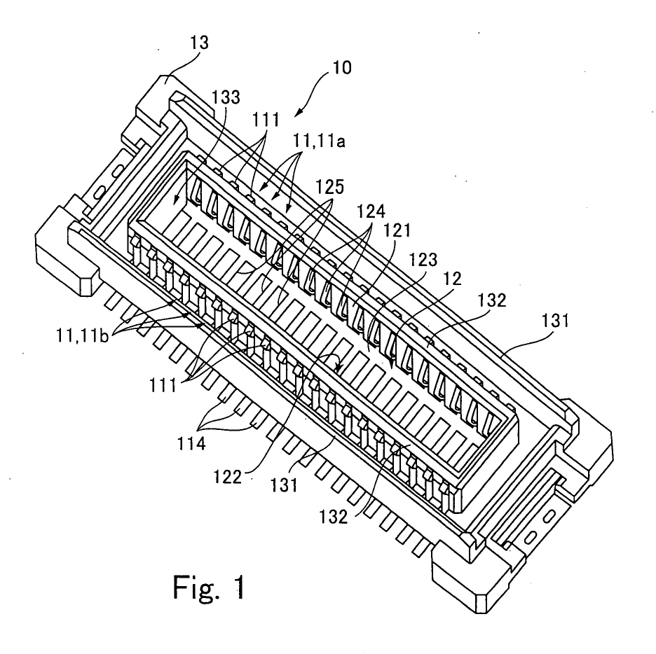

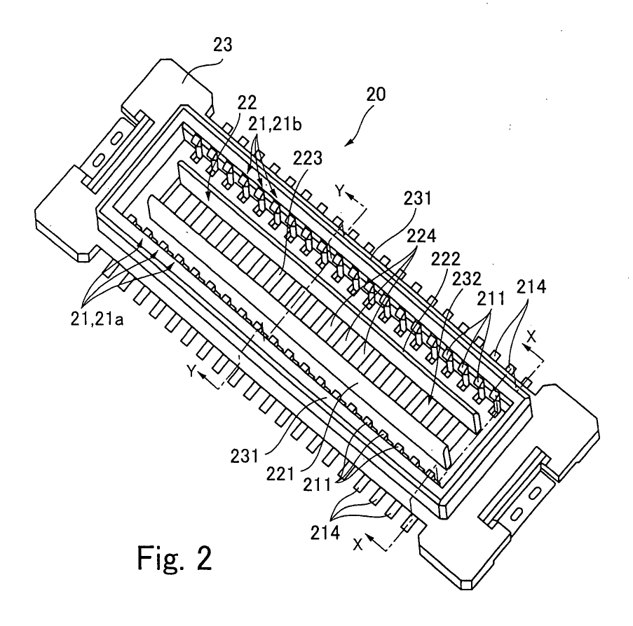

FIG. 1 shows a first connector 10 and FIG. 2 shows a second connector 20. The first connector 10 and the second connector 20 form an electrical connector assembly according to the invention. As shown in FIG. 1, the first connector 10 consists of a housing 13 having an outer wall 131 and a contact receiving wall 132. The outer wall 131 forms an outer perimeter of the housing 13. The contact receiving wall 132 stands on an inner side of the outer wall 131 and defines an opening 133. As shown in FIG. 4, a top edge of the contact receiving wall 132 has a protective lip 134 extending toward the outer wall 131.

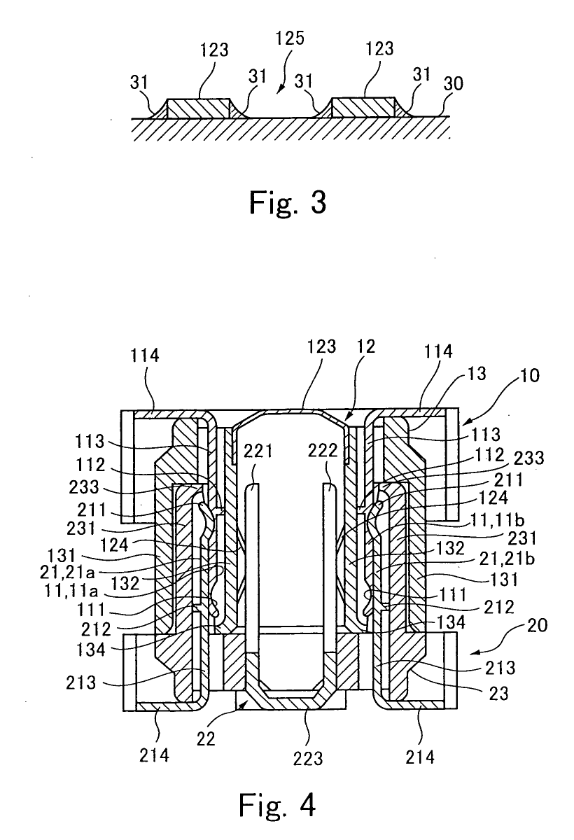

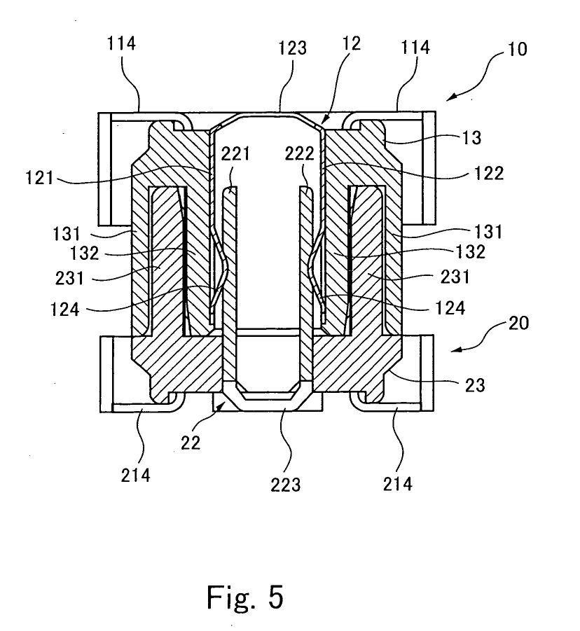

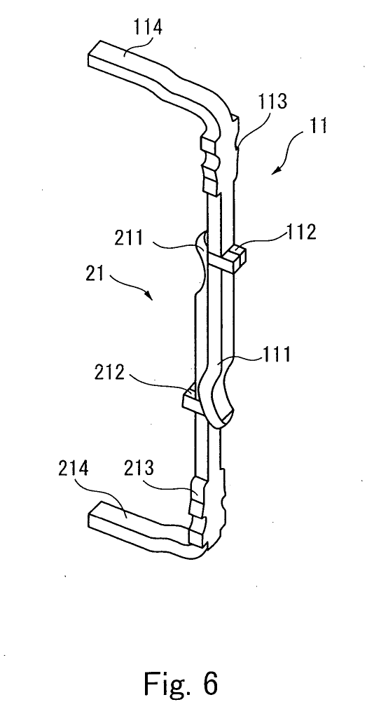

As shown in FIG. 1, contacts 11 are disposed in a first row 11a and a second row 11b in the housing 13. As shown in FIG. 6, each of the contacts 11 has a contact portion 111, a convex projection 112, a press-fit portion 113, and a terminal 114. The press-fit portions 113 are press-fit into the housing 13 such that the press-fit portions 113 spread in a direction of width (i.e., in a direction perpendicular to FIGS. 4-5) and are fixed into a wall that faces the direction perpendicular to FIGS. 4-5. As shown in FIG. 1, the contact portion 111 is arranged on an outer side of the contact receiving wall 132. As shown in FIG. 4, the convex projection 112 abuts against the outer side of the contact receiving wall 132 of the housing 13 of the first connector 10 to keep the contact portion 111 spaced from the contact receiving wall 132. The terminal 114 extends laterally and projects from a bottom surface of the housing 13 and is surface mounted or otherwise connected to a substrate 30 (FIG. 3).

As shown in FIG. 1, the housing 13 has a grounding member 12 shaped in the form of the letter U when viewed from a side thereof. The grounding member 12 includes a first grounding plate 121 and a second grounding plate 122. The first grounding plate 121 is arranged in a vicinity of the first row 11a of contacts 11, and the second grounding plate 122 is arranged in a vicinity of the second row 11b of contacts 11. The first and second grounding plates 121, 122 each have grounding contacts 124 formed by blanking and bending. A connecting plate 123 connects the first grounding plate 121 and the second grounding plate 122. The connecting plate 123 has a plurality of slots 125 and is disposed in the opening 133 of the housing 13 such that the first grounding plate 121 and second grounding plate 222 are held on the inner side of the contact receiving wall 132 of the housing 13. Because the first and second grounding plates 121, 122 are supported by the contact receiving wall 132 of the housing 13, the grounding member 12 of the first connector 10 may be formed from a thin plate material.

As shown in FIG. 3, the connecting plate 123 is surface mounted on a substrate 30 on which the first connector 10 is mounted. The connecting plate 123 is mounted to the substrate 30 with solder 31 such that peripheral edges of the slots 125 are soldered to the substrate 30. Because the peripheral edges of the slots 125 are soldered to the substrate 30, the connecting plate 123 is securely attached to the substrate 30. Additionally, because the slots 125 are arranged in the opening 133, it is possible to visually check the condition of the soldering.

As shown in FIG. 2, the second connector 20 consists of a housing 23 having a contact receiving wall 231. The contact receiving wall 231 forms an outer perimeter of the housing 23. As shown in FIG. 4, a top edge of the contact receiving wall 231 has a protective lip 233. As shown in FIG. 2, in a middle of the region enclosed by the contact receiving wall 231 is an opening 232 that extends in a longitudinal direction.

Contacts 21 are disposed in a first row 21a and a second row 21b in the housing 23. As shown in FIG. 6, each of the contacts 21 has a contact portion 211, a convex projection 212, a press-fit portion 213, and a terminal 214. The press-fit portions 213 are press-fit into the housing 23 such that the press-fit portions 213 spread in a direction of width (i.e., in a direction perpendicular to FIGS. 4-5) and are fixed into a wall that faces the direction perpendicular to FIGS. 4-5. As shown in FIG. 2, the contact portion 211 is arranged on an inner side of the contact receiving wall 231 of the housing 23. The contact portion 211 of the contact 21 of the second connector 20 has the same shape as the contact portion 111 of the contact 11 of the first connector 10 shown in FIG. 1. As shown in FIG. 4, the convex projection 212 of the second connector 20 abuts against the inner side of the contact receiving wall 231 of the housing 23 of the second connector 20 to keep the contact portion 211 spaced from the contact receiving wall 231. The terminal 214 extends laterally and projects from a bottom surface of the housing 23 and is surface mounted or otherwise connected to a substrate (not shown).

As shown in FIG. 2, the housing 23 has a grounding member 22 shaped in the form of the letter U when viewed from a side thereof. The grounding member 22 includes a first grounding plate 221 and a second grounding plate 222. The first grounding plate 221 is arranged in a vicinity of the first row 21a of contacts 21, and the second grounding plate 222 is arranged in a vicinity of the second row 21b of contacts 21. A connecting plate 223 connects the first grounding plate 221 and the second grounding plate 222. The connecting plate 223 has a plurality of slots 224 and is disposed in the opening 232 of the housing 23 of the second connector 20 such that the grounding member 22 is held by the housing 23. Because the first and second grounding plates 221, 222 of the first connector 20 stand alone, the grounding member 23 is supported by the rigidity of the grounding member 22 itself. Therefore, the grounding member 22 of the second connector 20 is formed from a thicker plate material having a larger rigidity than the grounding member 12 of the first connector 10 shown in FIG. 1. Because the grounding member 22 of the second connector 20 has a large enough rigidity to enable the grounding member 22 to stand alone, it is unnecessary to form a wall to support the first and second grounding plates 221, 222 of the grounding member 22. As a result, it is possible to minimize the size of the electrical connector assembly in a direction of width while maintaining the visibility of the connecting plates 123, 223.

The connecting plate 223 is surface mounted on a substrate (not shown) on which the second connector 20 is mounted in a manner similar to the connecting plate 123 of the first connector 10 shown in FIG. 3. The connecting plate 223 of the second connector 20 therefore has the same advantages as the connecting plate 123 of the first connector 10.

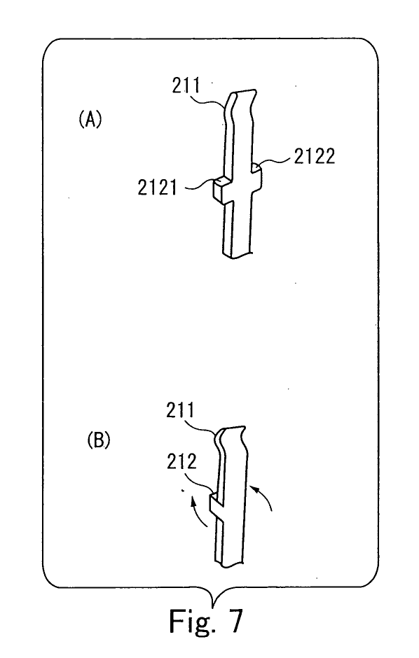

FIG. 7 is an explanatory drawing of a method of forming the convex projections 212 of the contacts 21 of the second connector 20. Because the convex projections 112 of the contacts 11 of the first connector 10 are formed in the same manner, a description thereof will be omitted. As shown in Part (A) of FIG. 7, projecting pieces 2121, 2122 extend in a direction of width and are formed by blanking a metal plate. The projecting pieces 2121, 2122 are then bent in a direction of the arrows shown in Part B) of FIG. 7 and an inward force is applied to form the convex projection 212.

FIGS. 4-5 show the first connector 10 mated with the second connector 20. During mating, the contact portions 111 of the contacts 11 of the first connector 10 and the contact portions 211 of the contacts 21 of the second connector 20 are elastically deformed such that the contact portions 111, 211 come into electrical contact with each other with a prescribed contact pressure that keeps the contact portions 111, 211 electrically connected. The surface of the contact portions 111, 211 that contact each other is a rolled surface formed from a surface of a flat metal plate. This surface is a smooth surface, which decreases the mating force and provides high contact reliability. The contact portions 111 of the contacts 11 of the first connector 10 and the contact portions 211 of the contacts 21 of the second connector 20 come into contact in a vicinity of the convex projections 212, 112. Because the convex projections 212, 112 are fixed in position by the respective housings 13, 23, contact between the contacts 11 of the first connector 10 and the contacts 21 of the second connector 20 is stable.

Also during mating, the grounding contact 124 of the first connector 10 interferes with the first and second grounding plates 221, 222 of the second connector 20 such that the grounding contact 124 of the first connector 10 is elastically deformed into contact with the first and second grounding plates 221, 222 of the second connector 20. The grounding contact 124 of the first connector 10 contacts the first and second grounding plates 221, 222 of the second connector 20 with a prescribed contact pressure. The grounding contact 124 of the first connector 10 is formed in such a manner that a portion of the grounding contact 124 of the first connector 10 is hidden behind the first and second grounding plates 221, 222 of the second connector 20.

As shown in FIG. 5, a first wall is formed close to the first rows 11a, 21a of contacts 11, 21 by the first grounding plates 121, 221 of the first connector 10 and the second connector 20, and a second wall is formed close to the second rows 11b, 21b of contacts 11, 21 by the second grounding plates 122, 222 of the first connector 10 and the second connector 20. The first and second walls serve to suppress crosstalk and thereby provide a structure suitable for high-speed signal transmission.

As shown in FIG. 4, the protective lip 134 formed on the contact receiving wall 132 of the housing 13 of the first connector 10 protects leading ends of the contact portions 111 of the contacts 11 of the first connector 10. Because there is no other projecting portion than the protective lip 134 on the outer side of the contact receiving wall 132, it is possible to fabricate the housing 13 by use of a split mold capable of being divided in a vertical direction of FIG. 4. Similarly, the protective lip 233 formed on the inner side of the contact receiving wall 231 of the housing 23 of the second connector 20 protects leading ends of the contact portions 211 of the contacts 12 of the second connector 20. Because there is no other projecting portion than the protective lip 233 on the inner side of the contact receiving wall 231, it is possible to fabricate the housing 23 by use of a split mold capable of being divided in the vertical direction of FIG. 4.

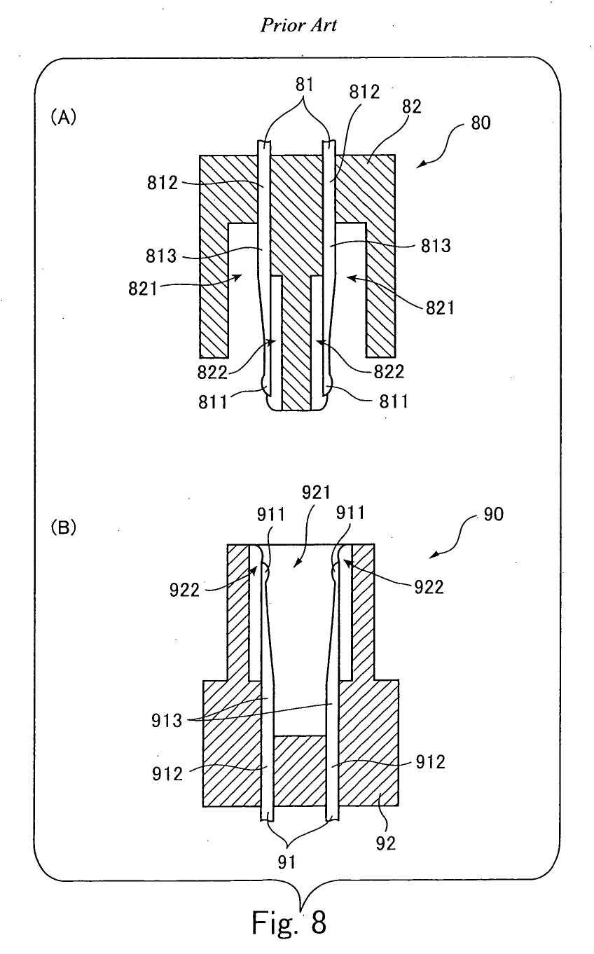

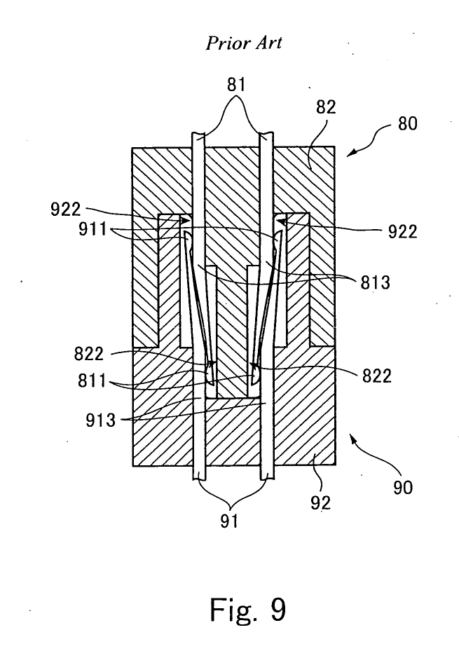

Because the convex projections 112, 212 are provided on the contacts 11, 21 of the first connector 10 and the second connector 20 and the protective lips 134, 233 are provided on the housings 13, 23 of the first connector 10 and the second connector 20, it is possible to protect the leading ends of the contact portions 111, 211 of the contacts 11, 21 of the first connector 10 and the second connector 20 without increasing costs. Additionally, because the contact portions 111, 211 come into contact within the vicinity of the convex projections 112, 212 upon engagement, contact occurs between an elastic portion of the contacts 11, 21 and an inelastic portion of the contacts 11, 21, which provides a stable electrical connection. Additionally, the convex projections 112, 212 are not deformed because the convex projections 112, 212 are in abutment with the respective housings 13, 23. The convex projections 112, 212 therefore perform the same role as the fixed sections of the contacts of the conventional electrical connector assembly shown in FIGS. 8-9.

1. An electrical connector assembly, comprising:
first and second connectors, the first and second connectors each having a housing with a contact receiving wall;
contacts disposed in the housings of the first and second connectors, each of the contacts having a contact portion, a terminal, a convex projection, and a press-fit portion, the convex projection being arranged between the contact portion and the press-fit portion, the convex projection abutting the contact receiving wall in the housing in which the contact is disposed to space the contact from the contact receiving wall when the first and second connectors are mated; and
a protective lip formed on the contact receiving walls of the first and second connectors, the protective lip being formed adjacent to the contact portions of the contacts.

2. The electrical connector assembly of claim 1, wherein the contact portions of the contacts of the first connector contact the contacts of the second connector in a vicinity of the convex projections of the contacts of the second connector when the first and second connectors are mated and the contact portions of the contacts of the second connector contact the contacts of the first connector in a vicinity of the convex projections of the contacts of the first connector when the first and second connectors are mated.

3. The electrical connector assembly of claim 1, wherein the contacts are arranged in first and second rows in each of the housings.

4. The electrical connector assembly of claim 1, wherein the contact receiving wall defines an opening in the housing of the first connector.

5. The electrical connector assembly of claim 4, further comprising a grounding member supported by the contact receiving wall of the first connector, the grounding member having a connecting plate disposed in the opening of the housing of the first connector.

6. The electrical connector assembly of claim 5, wherein the connecting plate of the grounding member of the first connector has a plurality of slots.

7. The electrical connector assembly of claim 1, wherein the second connector further comprises a grounding member positioned adjacent to an opening in the housing of the second connector.

8. The electrical connector assembly of claim 7, wherein the grounding member is rigid and stands alone in the housing of the second connector.

9. The electrical connector assembly of claim 8, wherein the grounding member of the second connector has a connecting plate disposed in the opening of the housing of the second connector.

10. The electrical connector assembly of claim 9, wherein the connecting plate of the grounding member of the second connector has a plurality of slots.

11. The electrical connector assembly of claim 1, wherein the contacts disposed in the first and second connectors are the same configuration.

12. A connector, comprising:
a housing having a contact receiving wall;
contacts disposed in the housing, each of the contacts having a contact portion, a terminal, a convex projection, and a press-fit portion, the convex projection being arranged between the contact portion and the press-fit portion, the convex projection abutting the contact receiving wall to space the contact from the contact receiving wall; and
a protective lip formed on the contact receiving wall, the protective lip being formed adjacent to the contact portions of the contacts.

13. The connector of claim 12, wherein the contacts are arranged in first and second rows in the housing.

14. The connector of claim 12, wherein the contact receiving wall defines an opening in the housing.

15. The connector of claim 14, further comprising a grounding member supported by the contact receiving wall, the grounding member having a connecting plate disposed in the opening.

16. The connector of claim 15, wherein the connecting plate has a plurality of slots.

17. The connector of claim 12, further comprising a grounding member positioned adjacent to an opening in the housing, the grounding member being sufficiently rigid to stand alone in the housing.

18. The connector of claim 17, wherein the grounding member has a connecting plate disposed in the opening.

19. The connector of claim 18, wherein the connecting plate a plurality of slots.
